(19) United States
(12) Patent Application Publication
(10) Pub. No.: US 2008/0049228 A1
(43) Pub. Date: Feb. 28, 2008

(54) Fabry-perot interferometer array

(75) Inventor: William S. Chan, Redwood City, CA (US)

Correspondence Address: William S. Chan, 1123 King Street, Redwood City, CA, 94061, US

(73) Assignee: NovaSpectra, Inc.

(21) Appl. No.: 11/510,815

(22) Filed: Aug. 28, 2006

(51) Int. Cl. G01B 9/02; G01J 3/45

(52) U.S. Cl. 356/454; 356/450

(57) ABSTRACT

This disclosure describes a fabry-perot interferometer array and methods of using it for gas sensing, hyper-spectral imaging, scene projection and optical communications. Processed on a silicon, silicon-on-sapphire, or other substrates with integrated circuits, the array may be sized from one pixel to multi-mega pixels and made to cover the entire ultraviolet (UV) to long wave infrared (LWIR) spectrum, allowing it to be used in many applications. In preferred embodiments, each pixel of the array is a fabry-perot interferometer cavity, sandwiched between two parallel mirrors, whose spacing is changed by moving one of the mirrors relative to the other with a voltage applied across the cavity, tuning it to transmit a waveband with a bandwidth and a central wavelength determined by the mirror reflectivity and the cavity spacing, respectively. Thus, an array of different wavebands may be electrically tuned to transmit from the array.

### GOVERNMENT RIGHTS

The present invention was sponsored by the U.S. Air Force, under sponsored research contract # F33615-03-5405, and by the U.S. Army under sponsored research contracts # W31P4Q-04-C-R006 and # W15QKN-04-C-1007. The Government holds certain rights to this invention.

### TECHNICAL FIELD

The present invention relates to a fabry-perot interferometer array apparatus and methods of using it for many different applications, more particularly, to apparatus and methods that electrically tune the fabry-perot interferometer array to select an array of narrow wavebands for gas sensing, hyper-spectral imaging, scene projection, and optical communications over the ultraviolet (UV) to long wave infrared (LWIR) spectral range.

### BACKGROUND OF THE INVENTION

### Fabry-Perot Interferometer

The fabry-perot interferometer, developed by Fabry and Perot (Fabry, C. and Perot, A., C.R. Acad. Sci., 126, p 331, 1898) as a measurement standard, is used extensively as a precision interferometer and an optical filter, whose theory has been discussed by Vaughan (Vaughan, J. M., Adam Hilger Publisher, Philadelphia, 1989). As an interferometer, it consists of two parallel mirrors sandwiching a narrow air-gap cavity. On entering this cavity, an incident radiation beam subjected to multiple reflections is divided into multiple beams interfering with one another to produce a narrow waveband with a bandwidth and a central wavelength determined by the mirror reflectivity and the cavity spacing, respectively. Since both are controllable over a large range, this cavity is capable of producing wavebands over a wide spectral range, from ultraviolet (UV) through mid wave infrared (MWIR) to long wave infrared (LWIR).

By changing its spacing, the cavity is tuned to transmit different wavebands. This can be achieved simply by moving one mirror relative to the other with a voltage applied across a piezoelectric spacer placed between the mirrors. However, cavities made with bulky mirrors and spacers are difficult to move with the high precision needed for interference. Further, thousands of volts are needed across the piezoelectric spacer to change the spacing required. As a result, making arrays with conventional bulky fabry-perot cavities is impractical. But, arrays, especially dense ones, are sought for many applications such as gas sensing, hyper-spectral imaging, scene projection, and optical communications.

For a wide range of applications, the fabry-perot interferometer needs to be made into a micro cavity, the micro cavity into an array, and the array into a configuration with a proper cavity spacing to suit the application. For example: a cavity spacing of 0.3 micron for displays; 5.0 micron for hyper-spectral imaging; 2.5 micron for gas sensing; and 5.0 micron for scene projection. For diverse applications, the cavity spacing should therefore range from 0.3 micron to 5.0 micron.

### Diverse Applications

Refinements of conventional fabry-perot cavities have remained bulky and heavy in construction, making them clumsy and costly for gas sensing, hyper-spectral imaging, scene projection, and optical communications applications. But recent advances in micromachining have produced micro cavities capable of interference just as good as bulky cavities (for example: Jerman, J. H. et al., International Conference on Solid-State Sensor and Actuators, p 372, 1991; and Zavracky, P. M., et al., “Miniature Fabry Perot Spectrometer Using Micromachining Technology,” ESCON '95 Conf., Microelectronics Communications Technology Producing Quality Products, p 325, 1995).

However, these micro cavities are limited to the near infrared (NIR, 1-1.8 micron) and have not been made into an array form of any consequence. For example, U.S. Pat. No. 6,947,218, U.S. Pat. No. 6,958,818, and U.S. Pat. No. 4,756,606 have disclosed fabry-perot interferometers that are still single-cavity and sensitive only to the NIR.

The U.S. Pat. No. 4,825,262, and U.S. Pat. No. 6,836,366 have disclosed a diaphragm and a membrane mechanism, respectively, for changing the cavity spacing in tuning that are not amenable to large spacing changes to cover the spectral range from UV to LWIR.

The U.S. Pat. No. 5,550,373 has disclosed a piezoelectric film stack for tuning over the 2-12 micron spectral range that is neither amenable to array fabrication nor operable at low voltages compatible with conventional integrated circuits.

The U.S. Pat. No. 6,597,461 has disclosed an interferometer made with entropic materials for tuning that is susceptible to thermal, mechanical and chemical instability over time, especially when it is configured in the array form, for which structural stability is a paramount requirement.

The U.S. Pat. No. 6,822,798 has disclosed a deformable membrane for tuning that is not amenable to making arrays of fabry-perot interferometers.

To be useful for a wide range of applications, array sizes starting from 128×128 to beyond 1,024×1,024 are needed. Further, the micro cavity must be made tunable throughout the UV to LWIR (0.28-14 micron) region. In gas sensing, the gases of interest usually have their primary absorption bands in the MWIR and LWIR, not accessible by the micromachined micro fabry-perot interferometers developed for the NIR. U.S. Pat. No. 6,590,710 has disclosed a fabry-perot interferometer tuned for gas sensing in the MWIR spectral region that is limited to only a few gas absorption wavebands.

Hyper-spectral imaging, each pixel of which is a spectrometer, provides a powerful method of detecting and discriminating targets from confusing clutter and disruptive objects by invoking hyper-spectral sensitivity for pattern recognition. No hyper-spectral imaging systems using multi-dimensional interferometer arrays are available commercially for imaging over a wide spatial as well as a wide spectral range.

In gas cloud sensing, no dense arrays exist to go with a dense arrays of infrared detectors to sense spatial, spectral as well as temporal distributions of flammable (hydrocarbons), polluting (nitrous oxide), and toxic gases (hydrogen sulphide) of interest to the safety, security and chemical process industries.

In optical communications, wavelength division multiplexing (WDM) uses a single interferometer, and dense wavelength division multiplexing (DWDM) uses an array. But such an array usually is limited to only a few elements.

Free-space optical communications can take advantage of the NIR and LWIR regions. The former region has the advantage of the availability of a powerful Yag laser at about 1.06 micron and a sensitive silicon detector array, but it suffers from a high atmospheric absorption. The latter has the advantage of a low atmospheric absorption at 10 micron, but it lacks a sensitive LWIR detector array and an LWIR fabry-perot interferometer array.

Using optical interconnects between microchips over short distances (less than 0.5 meter), high data rates in excess of 20 Gbits/s are achieved using an array of micro fabry-perot interferometers along with a laser to transmit massively-parallel near infrared channels through space onto a receiving silicon detector array avoiding using electrical connections. But in this area, no interferometer array is yet available.

In testing imaging sensors, especially those used in military applications, dynamic scene projection systems in the UV, visible (V), MWIR and LWIR are required to generate and then project complex, dynamic scenes onto sensors to test their behavior under various engagement environments. Current scene projection systems, especially those in the MWIR and LWIR spectral regions, are limited in fidelity, speed, dynamic range and spatial resolution. Advanced arrays are needed that can be illuminated with laser sources to project complex scenes in the UV, V, MWIR and LWIR spectral regions for high fidelity, high speed, high dynamic range and high spatial resolution.

### Prior Art Limitations

Prior art electrically-tunable fabry-perot interferometer arrays are limited in spatial resolution, cavity spacing, spectral coverage, frame rate and fabricability as follows:
(a) Spectral coverage limited to NIR-MWIR.
(b) Array size limited to less than 100 pixels.
(c) Cavity spacing limited to less than 1 micron.
(d) Frame rate limited to less 60 Hz.
(e) Fabrication of array limited to interferometer elements with no integrated circuits.

It is therefore an object of the invention to provide a micro fabry-perot interferometer array with cavities tunable electrically to transmit narrow wavebands over the UV-LWIR spectral region.

It is another object of the invention to provide a micro fabry-perot interferometer array with a spatial resolution ranging from one cavity to millions of cavities.

It is another object of the invention to provide a micro fabry-perot interferometer array with a cavity spacing varied from at least 0.3 micron to at least 5.0 micron, configurable to the entire UV-LWIR spectral region.

It is another object of the invention to provide a micro fabry-perot interferometer array containing integrated circuits to access, tune and correct cavities for non-parallelism at a frame rate greater 60 Hz.

It is another object of the invention to provide a micro fabry-perot interferometer array that can be fabricated by conventional integrated-circuit processes.

It is another object of the invention to provide a micro fabry-perot interferometer array configurable to many applications that include gas sensing, hyper-spectral imaging, scene projection, and optical communications.

### SUMMARY OF THE INVENTION

The invention comprises several general aspects. Each of these can if desired be combined with additional features, including features disclosed and/or not disclosed herein, resulting in combinations representing more detailed optional embodiments of these aspects.

In accordance with the present invention, there is provided an electronically tunable micro fabry-perot interferometer array. Like a microchip, it can be processed to contain one pixel or many millions of pixels. Each pixel is a micro cavity consisting of at least two parallel mirrors sandwiching an air-gap. At least one mirror suspended by at least one cantilever or other moveable supporting structure is made to move with respect to the other mirror by applying a voltage, such that a voltage differential exists across the cavity or within the supporting structure, thus changing the cavity spacing to transmit a narrow waveband throughout the UV-LWIR spectral region.

This applied voltage may be controlled by circuitry incorporated with each cavity. The same circuitry may be used to tilt the moving mirror into parallel with respect to the fixed one, correcting any non-parallelism that might have been created during fabrication, making the array uniform, a requirement of many applications.

This invention emphasizes making the micro cavity, forming it into an array, and configuring the array into applications. In accordance with this invention, arrays ranging from one cavity to many million cavities are made suitable for many applications that include: gas sensing, hyper-spectral imaging, scene projection, and optical communications.

A first aspect of the invention is an array of micro fabry-perot cavities for tuning radiation wavebands, wherein the set of cavities in said array may comprise at least one cavity in a first dimension and at least one cavity in at least one other dimension.

In various embodiments of this aspect the first and other dimensions may be orthogonal to one another, or may be at some angle other than orthogonal to one another.

In other embodiments, the array may further comprise circuitry to operate and/or tune the array. In certain forms of these embodiments, the circuitry may comprise integrated circuits. In certain related forms, the integrated circuits may be integral to the array or to the substrate on which the array is contained.

In yet another embodiment, each cavity of the array may comprise at least one top mirror and at least one bottom mirror, wherein said top and bottom mirror sandwich an air-gap cavity with a cavity spacing. In certain forms of this embodiment each top mirror may comprise at least one top mirror segment, and each bottom mirror may comprise at least one bottom mirror segment. In other forms of this embodiment each top and/or bottom mirror(s) may comprise a plurality of mirror segments. In certain specific embodiments, there is a one-to-many relationship between a top mirror (one) and its related bottom mirror segments (many). In general, although each discrete mirror may comprise multiple segments, the mirror/mirror segments are discussed below as a group generically as “mirror elements”. However, when required, the distinction between a mirror and its segments is identified.

In other embodiments, the top and/or bottom mirror element(s), may be suspended by at least one support structure. In various forms of these embodiments, the support structure may be anchored to the substrate via at least one anchor. In various other forms of these embodiments, the support structure may be a cantilever. In various related forms, the cantilever may be parallel to at least one side of at least one mirror, or may be parallel to two neighboring sides of the top mirror. In related forms, the mirrors element(s) are suspended by the support structure wherein at least one end of said structure is anchored to the substrate via at least one anchor, and the other end is in direct contact with the mirror element(s).

In other forms of these embodiments, the top mirror element(s) may be moved via the support structures relative to the bottom element(s). In related forms, the movement of the top mirror element(s) may result from the flexing of at least one support structure. In other forms the movement of the top mirror element(s) may result from an electrostatic force created by applying a voltage across the air-gap cavity, or applied directly to at least one mirror element. The movement may be toward or away from at least one bottom mirror element(s).

In yet other forms of these embodiments, the movement of a top mirror element(s) may correct for non-parallelism between the top mirror element(s) and the bottom mirror element(s). In still other forms, a voltage applied to a bottom mirror element(s) may cause the top mirror element(s) to become substantially parallel with the bottom mirror element(s).

In still other forms of these embodiments, the movement of a top mirror element(s) may tune a cavity to transmit at least one spectral waveband. In still other forms, a voltage applied to a bottom mirror element(s) may change the distance from the top mirror element(s) to the bottom mirror element(s), changing the cavity air-gap to a distance corresponding to at least one spectral waveband.

In yet other forms of these embodiments, the cavity spacing may be preset to generate at least one spectral region. In still other forms, the cavity spacing may be preset to generate at least one specific spectral region via altering the height of at least one of the support structure's at least one anchor.

In still other forms of these embodiments, the cavities of the array may be tuned from a first to a second waveband in less than 1 microsecond. In related forms, the difference between the first and second wavebands corresponds to the difference between the maximum and minimum wavebands available. In other related forms, the maximum and minimum wavebands available correspond to frequency from 300 GHz to 30 PHz. In other forms of these embodiments, the array may have a frame rate of at least 1,000 Hz. In still other forms, the array may have a frame rate of at least 10,000 Hz.

In other forms of these embodiments, each mirror element may comprise at least one bilayer or a plurality of bilayers. In related forms, each bilayer may comprise a dielectric film of high refractive index and a dielectric film of low refractive index, producing a specific reflectivity in the mirror element. In other related forms, the dielectric film of high refractive index closest to and on either side of the air-gap cavity may comprise a doped medium so that the film is more electrically conducting than the film of low refractive index, producing a uniform distribution of an applied voltage over the film.

A second aspect of the invention is an apparatus for gas sensing comprising at least one micro fabry-perot interferometer element, at least one detector element, an infrared source, a collimating lens, a gas path length, a cavity controller, a detector controller, and a control processor, wherein gas of a specific type located between the infrared source and said at least one micro fabry-perot interferometer element can be detected.

In one embodiment of this second aspect, multiple gas sensing apparatus may be combined to create an apparatus for gas cloud sensing, comprising: an array of micro fabry-perot interferometer elements, a multi-element infrared detector array, an imaging lens, an infrared detector array controller, and a micro fabry-perot-interferometer array controller, wherein a plurality of gas types located between an infrared source and said micro fabry-perot interferometer array can be detected simultaneously.

In various forms of this embodiment, the cavities of said apparatus may be tuned: to a waveband absorbed by a gas in a gas cloud, to obtain a spatial distribution of the gas; to different wavebands absorbed by different gases sequentially, to obtain a sequence of spatial distributions of different gases in the gas cloud; to a different waveband absorbed by a different gas, to obtain a single distribution of different gases in the gas cloud; to a waveband absorbed by a gas product resulted from a chemical reaction, to obtain a single distribution of different gas products; and/or variably, to obtain spectral, spatial, temporal, chemical reaction and concentration distributions of the gas cloud nearly simultaneously. In another form, the apparatus may comprise means for performing said tuning.

This second aspect further comprises a method for gas sensing, comprising collimating at least one infrared beam through a gas onto at least one interferometer element; tuning the cavity of the interferometer element(s) a first time to transmit a waveband absorbed by the gas; tuning said cavity a second time to transmit another waveband not absorbed by the gas as a reference; sensing the absorbed waveband and the non-absorbed waveband sequentially with a detector element; and computing a concentration of the gas with a ratio of a signal due to the absorbed waveband to a signal due to the non-absorbed waveband, according to: CG=A.Log(Q), where CG is said concentration, Q is said ratio, and A is a constant obtained by calibration with a known concentration of the gas.

In a related embodiment to this aspect, the method for gas sensing may further comprise a method for computing a low concentration if said low concentration is less than one part per million of said gas with said ratio, according to:

### CG=AO+A1.Log(Q)+A2.[Log(Q)]², where CG is said low concentration, Q is said ratio, and AO, A1 and A2 are constants obtained by calibration with at least three known concentrations of said gas before sensing.

A third aspect of this invention is an apparatus for hyper-spectral imaging comprising a micro fabry-perot interferometer array, an infrared detector array, an imaging lens, an infrared-detector-array controller, and a micro fabry-perot interferometer array controller, wherein data collected by said array may provide a multi-spectral, multi-spatial, and/or temporal image of targets and background.

In various embodiments of this third aspect, the cavities of said apparatus may be tuned: to a specific waveband, to obtain a spatial image at said waveband; to one waveband at different times, to obtain a sequence of spatial images at waveband; to different wavebands sequentially, to obtain a sequence of spatial images of said different wavebands; to different wavebands simultaneously, to obtain a single spatial image of different wavebands; in segments, to different wavebands to correspond to different targets, to obtain images of targets enhanced against background; and/or variably, to obtain spectral, spatial, and temporal images nearly simultaneously of targets and background. In another embodiment, the apparatus may comprise means for performing said tuning.

A fourth aspect of this invention is an apparatus for projecting scenes, comprising a micro fabry-perot interferometer (MFPI) array, a laser source, a collimator, a focusing lens, a laser controller, and an MFPI array controller, wherein the cavities of said MFPI array may be independently tuned to generate at least one scene.

In one embodiment of this aspect, the MFPI array may generate a sequence of scenes. In another embodiment, the scene(s) may be projected onto a sensor under test. In various related embodiments, MFPI arrays and matched laser sources specific to particular wavebands may be used independently or in combination to project scenes comprising one or more wavebands from among short-wave IR, mid-wave IF, long-wave IR, visible light and/or ultraviolet. When used in combination, the projected scenes can comprise multiple wavebands simultaneously.

This fourth aspect further comprises a method for testing a sensor using an MFPI array comprising: illuminating at least one MFPI array with a laser source; tuning at least some of the cavities of said MFPI array(s) to at least one waveband producing at least one scene; projecting the scene(s) onto the sensor under test; and recording the response of the sensor under test using a sensor controller.

A fifth aspect of this invention is an apparatus for optical communications comprising at least one micro fabry-perot interferometer (MFPI) array, at least one laser source, a projector lens, a laser controller, and an MFPI array controller, wherein at least one optical channel is coded with data for transmission through free space to at least one distant optical receiver.

In one embodiment of this aspect, a plurality of optical channels may be simultaneously coded with data for transmission. In other embodiments, the optical channel(s) may be coded with data for transmission through free space on one or more wavebands using at least one MFPI array and matched laser source in the short-wave IR, mid-wave IF, long-wave IR, visible light and/or ultraviolet wavebands. In a related embodiment, at least two separate wavebands can be simultaneously transmitted through the use of at least two distinct MFPI arrays and matched laser sources.

In yet another embodiment, the optical communications provide for at least one microchip-to-microchip optical interconnect.

This fifth aspect further comprises a method for transmitting data via optical communications comprising: illuminating at least one micro fabry-perot interferometer (MFPI) array with a laser source; tuning the cavities of the MFPI array to different wavebands producing different optical channels; coding the optical channels with data for communication; and projecting the optical channels through free space onto a distant receiver.

A sixth aspect of this invention is a method for fabricating a fabry-perot interferometer array, comprising: obtaining a substrate of a specific material quality; fabricating a set of integrated circuits for the array onto said substrate, using standard micro-electronic fabrication techniques; fabricating the bottom mirrors above the integrated circuits; creating a sacrificial layer above the bottom mirrors; creating a supporting structure to be used to support the top mirrors within the sacrificial layer; fabricating the top mirrors above the support structures; and removing the sacrificial layer leaving behind said support structures; thus, forming the array.

In various embodiments of this aspect, the substrate may be Silicon, Silicon-on-Sapphire, diamond, and/or glass. In another embodiment, the support structure may be a cantilever.

### ADVANTAGES OF THE INVENTION

The following discussion of advantages is not intended to limit the scope of the invention, nor to suggest that every form of the invention will have all of the following advantages. As will be seen from the remainder of this disclosure, the present invention provides a variety of features. These can be used in different combinations. The different combinations are referred to as embodiments. Most embodiments will not include all of the disclosed features. Some simple embodiments can include a very limited selection of these features. Those embodiments may have only one or a few of the advantages described below. Other preferred embodiments will combine more of these features, and will reflect more of the following advantages. Particularly preferred embodiments, that incorporate many of these features, will have most if not all of these advantages. Moreover, additional advantages, not disclosed herein, that are inherent in certain embodiments of the invention, will become apparent to those who practice or carefully consider the invention.

The foregoing and other objects of the invention are achieved by the apparatus and systems described herein which overcome problems inherent in traditional fabry-perot interferometers, and in the use of such interferometers in fields such as gas sensing, gas cloud sensing, hyper-spectral imaging, scene projection, and optical communications (both long distance and short distance).

In particular, an electronically tunable micro fabry-perot interferometer (MFPI) has, by its nature, a compact form factor which allows multiple cavities to be “built” on a microscopic level. As such, one of the first advantages is that the device, and systems using the device are able to be exceedingly small in size. In conjunction with the reduction in size, the power requirements of such a device, and in particular, the voltages required to tune the device are significantly lower than those used in current commercially available interferometers. Lastly, by reducing the size and power requirements of the device, the device can be assembled together with its control circuitry on a single integrated circuit (IC) using conventional IC processing.

With respect to gas sensing, the use of an MFPI offers the ability to tune to a wide selection of wavebands over a large spectral range, as opposed to current offerings which are limited to either a single or a few wavebands. Thus, an advantage of gas sensing using an MFPI is the creation of more robust sensors which are more capable of detecting many gases nearly simultaneously, of providing quantitative as well as qualitative analysis of the environment containing a mixture of gases, and of computing concentrations during sensing.

With respect to gas cloud sensing and hyper-spectral imaging, systems constructed with an MFPI array offers the advantage of being able to be variably tuned to obtain spatial, spectral and temporal behaviors, or some combination of these behaviors. Particularly in gas cloud sensing, these systems can be used to show how a particular gas within a gas cloud varies in concentration in both space and time, how the gas cloud moves or disperses within a particular geographic location, or how the different component gases within the cloud mix chemically. When used in hyper-spectral imaging, some of the more prominent advantages include the capability to highlight objects based on specific wavebands, the capability to track an object embedded in noisy and cluttered background, and the capability to collect multiple objects with different waveband characteristics simultaneously, allowing the ability to discern behaviors of multiple objects over temporal, spatial and spectral extents.

With respect to scene projection, systems that incorporate an MFPI array or set of arrays offer advantages in that the specific elements of array(s) can be permanently or variably tuned in spectral, spatial, and temporal behaviors, or some combination of these behaviors to generate a complex scene or a series of complex scenes from the array onto a sensor. The ability to tune each cavity independently offers the capability to vary the intensity selectively about a primary wavelength, allowing different intensities in a scene to be generated. And by combining multiple arrays with multiple sources set at different wavebands, scenes may be generated from either a single source, or from a combination of sources along a wide band of frequencies.

With respect to optical communications, the use of an MFPI array offers advantages of increased capabilities and decreased costs associated with both long distance and short distance communications by providing massively parallel optical channels for data transmissions, and the ability to vary the transmission waveband allowing such devices to overcome changing environmental characteristics.

### BRIEF DESCRIPTION OF THE DRAWINGS

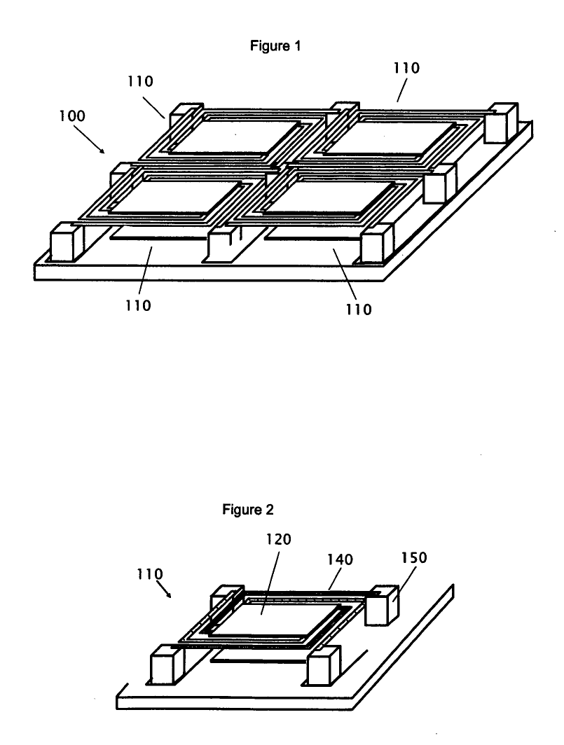

### FIG. 1: MFPI Array

FIG. 1 comprises a micro fabry-perot interferometer (MFPI) array 100 showing four MFPI pixels 110.

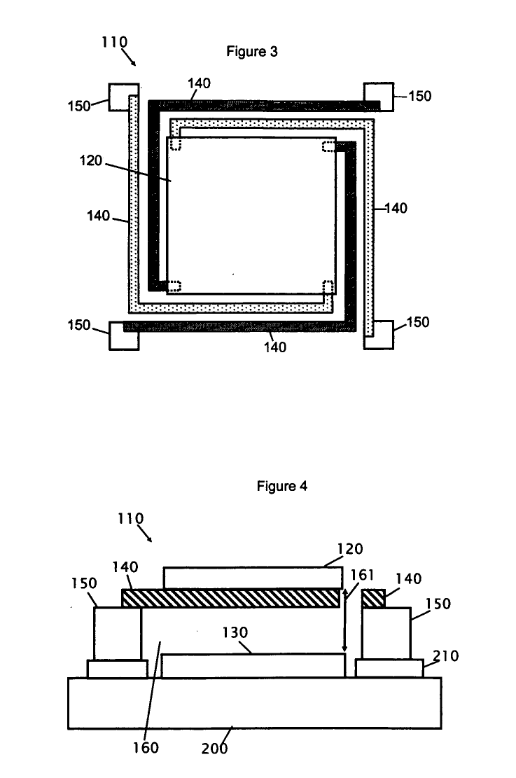

### FIGS. 2-3: MFPI pixel

FIGS. 2 and 3 comprise a single MFPI pixel 110 from FIG. 1. Each pixel 110 is a MFPI cavity comprising of a top mirror 120, multiple cantilevers 140, and multiple anchors 150.

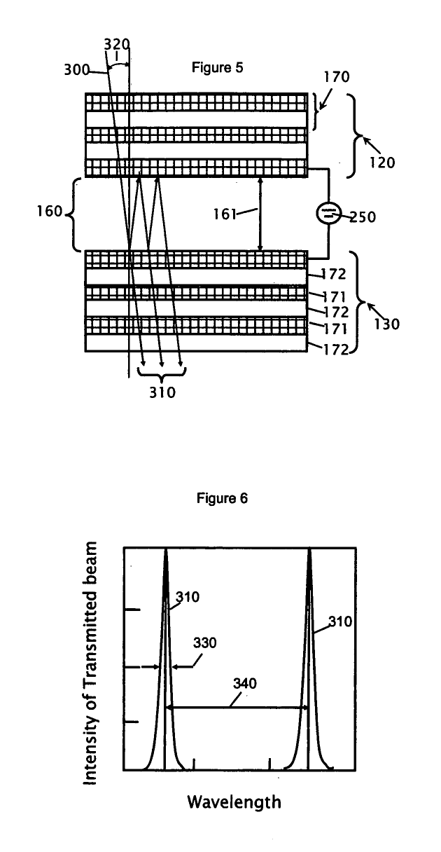

### FIGS. 4-5: Side View of a Pixel

FIGS. 4 and 5 comprise a single MFPI cavity 110.

FIG. 4 comprises a top mirror 120, bottom mirror 130, cantilever 140, anchor 150, air gap cavity 160 and a cavity spacing 161, a substrate 200, and an input circuit 210.

FIG. 5 is a close-up view centered on the air-gap cavity 160 of FIG. 4 comprising a top mirror 120, bottom mirror 130, air-gap cavity 160, cavity spacing 161, multiple bilayers 170 comprising a first 171 and second 172 dielectric layer, an incident radiation beam 300 with an angle of incidence 320, a waveband with a narrow bandwidth 310, and a voltage 250.

### FIG. 6: Intensity Graph

FIG. 6 is a plot of intensity against wavelength of transmitted waveband 310 from MFPI cavity 110, showing bandwidth 330 and free spectral range 340.

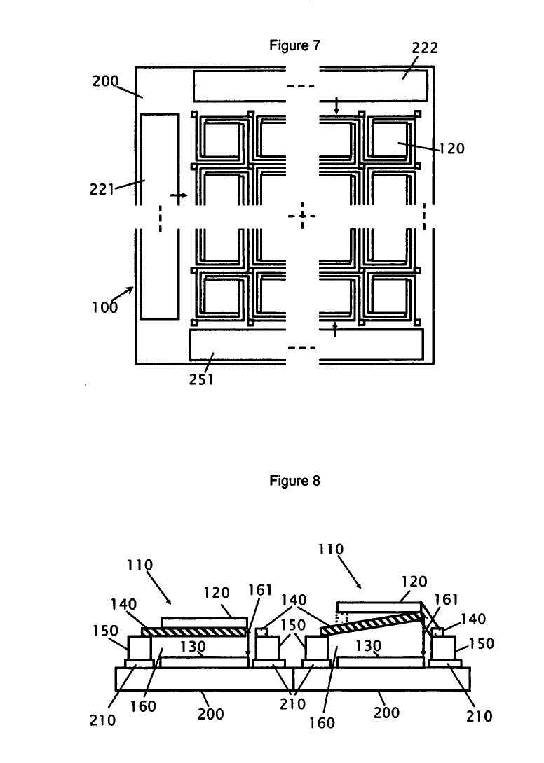

### FIG. 7: 2-D Array

FIG. 7 comprises an MFPI array 100 consisting of a substrate 200, row decoder 221, column decoder 222, and a voltage generator 251.

### FIG. 8: Cavity Spacing Change

FIG. 8 comprises two MFPI cavities 110, each with a top mirror 120, bottom mirror 130, cantilever 140, anchor 150, air gap cavity 160 and a cavity spacing 161, substrate 200, and input circuit 210.

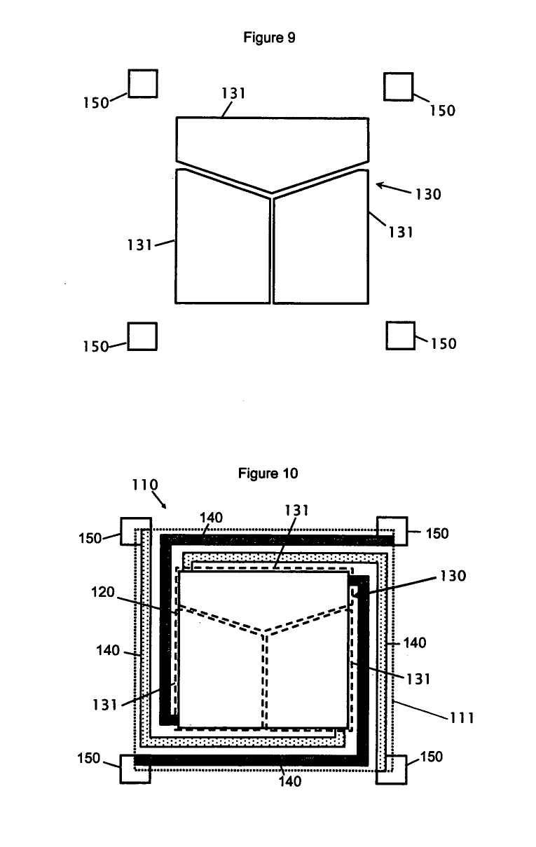

### FIG. 9: Bottom Mirror/Mirror Segments

FIG. 9 comprises a bottom mirror 130, multiple bottom mirror segments 131, and multiple anchors 150.

### FIG. 10: Top and Bottom mirror

FIG. 10 comprises an MFPI cavity 110, with a top mirror 120, a bottom mirror 130 comprising multiple bottom mirror segments 131, four cantilevers 140, four anchors 150, and a pixel boundary 111.

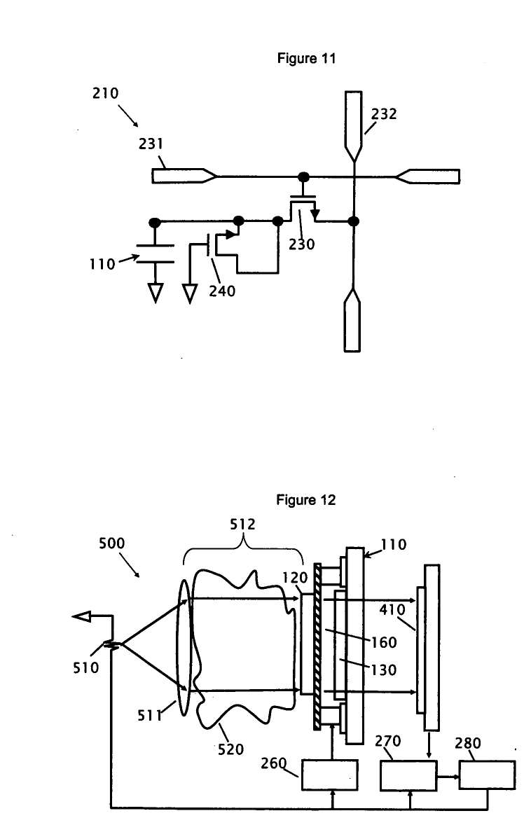

### FIG. 11: Input Circuit

FIG. 11 comprises an input circuit 210, with a row select 231, column select 232, select transistor 230, integrating capacitor 240, and a connection made to an MFPI cavity 110.

### FIG. 12: Gas Sensing—Single Element

FIG. 12 is a gas sensing system 500 comprising an MFPI element 110 comprising a top mirror 120, bottom mirror 130, and cavity spacing 160, a detector element 410, infrared source 510, collimating lens 511, gas path length 512, gas 520, cavity controller 260, detector controller 270, and control processor 280.

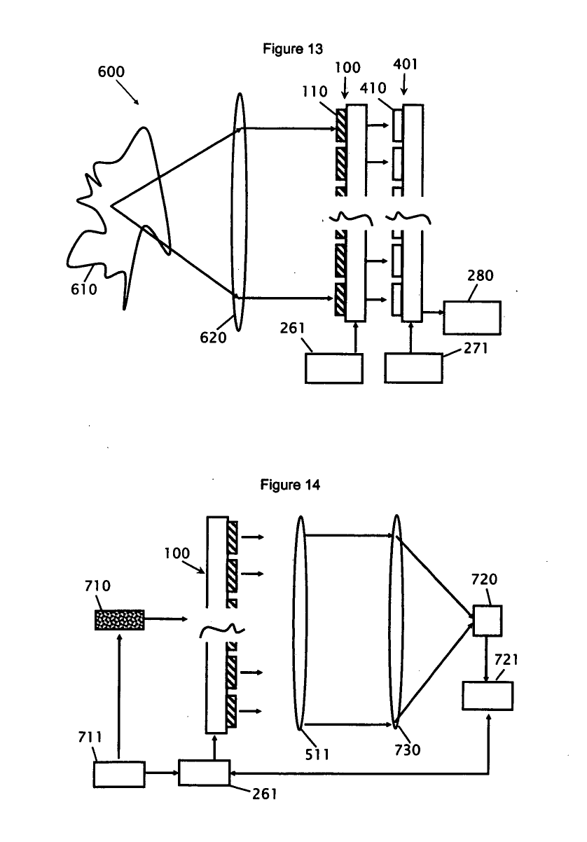

### FIG. 13: Imaging & Gas Cloud Sensing

FIG. 13 is a hyper-spectral imaging and gas cloud sensing system 600 comprising a target with background or IR source 610, an imaging lens 620, an MFPI array 100 of multiple MFPI elements 110, an IR detector 401 of multiple detector elements 410, an MFPI array controller 261, a detector array controller 271, and a control processor 280.

### FIG. 14: Scene Projection

FIG. 14 is a scene projection system 700 comprising a laser source 710 and laser controller 711, an MFPI array 100 and an MFPI array controller 261, a collimating lens 511, a focusing lens 730, and a sensor 720 and a sensor controller 721.

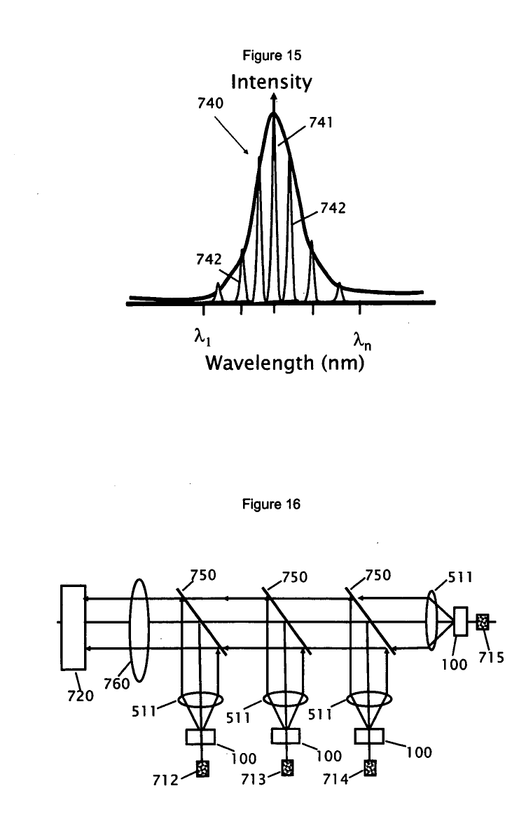

### FIG. 15: Scene Projection—Intensity modulation of Source

FIG. 15 is a plot of variation in intensity of a laser beam over a range of wavelengths, comprising the laser intensity profile 740, a primary projected wavelength 741, and multiple narrower wavebands 742.

### FIG. 16: Scene Projection—Multiple Sources

FIG. 16 is a scene projection system 700 comprising a sensor under test 720, multiple laser sources 712, 713, 714, and 715, each with an MFPI array 100 and collimating lens 511, multiple beam splitters 750, and a focusing lens 730.

### DETAILED DESCRIPTION OF THE DRAWINGS

### FIG. 1: MFPI Array

FIG. 1 is a perspective view of a typical micro fabry-perot interferometer (MFPI) array 100 showing four adjacent MFPI cavity 110 pixels. In this example, the array is 2 pixels wide by 2 pixels high.

MFPI arrays can be created in multiple dimensions, including three dimensions (traditional x, y, and z coordinates). These dimensions need not be orthogonal, although the drawings shown are simplified to aid understanding by showing only two dimensional images, or at most, a perspective view.

In general, a generic array comprises multiple sensing or generating elements. Thus, the terms cavity, pixel, and element are somewhat interchangeable. When discussing an MFPI array, it is common to discuss the number of elements or pixels. When discussing a discrete pixel or element, or in particular, its component parts, cavity is commonly used.

### FIGS. 2-3: MFPI Pixel

FIGS. 2 and 3 are detailed perspective view and a top view, respectively, of a single pixel 110 from FIG. 1. Each pixel comprises a top mirror 120 suspended by multiple cantilevers 140, each of which is fastened to an anchor 150. In this example, each of the four cantilevers is shown with a schematic texture to aid in observing the structure and connections between the anchors, cantilevers and top mirror.

This invention also includes other mirror geometries (other than rectangular), other cantilever geometries, other numbers and types of cantilevers and anchors, and different connection points between the cantilever(s), mirror(s) and anchor(s), any of which can be substituted for that which is currently shown. Additionally, structures other than cantilevers can be used to suspend the mirror elements while allowing them to move as required to tune the cavity or achieve parallelism with other mirror elements.

### FIGS. 4-5: Side View of a Pixel

FIGS. 4 and 5 detail a side view of a single MFPI cavity 110. FIG. 4 details the relative positions of a top mirror 120, bottom mirror 130, cantilever 140, anchor 150, air gap cavity 160, substrate 200, and input circuit 210, where the top and bottom mirror are separated by a cavity spacing 161. FIG. 5 is a close-up view of FIG. 4 centered on the air-gap cavity 160, showing additional detail in the top and bottom mirrors, each of which comprise multiple bilayers 170, with each bilayer comprising a first 171 and a second 172 dielectric layer.

In FIG. 5, an incident radiation beam 300 with an angle of incidence 320, undergoes multiple reflections within air-gap cavity 160, emerging from the cavity as a waveband with a narrow bandwidth 310. Additionally, FIG. 5 details how the application of a voltage 250 across the air-gap cavity 160 can be used to change the gap spacing 161.

### FIG. 6: Intensity Graph

FIG. 6 is a plot of intensity against wavelength of transmitted waveband 310 from an MFPI cavity 110, showing bandwidth 330 and free spectral range 340.

### FIG. 7: 2-D Array

FIG. 7 is a two-dimensional (m×n) MFPI array 100 of arbitrary width m by arbitrary height n, where the array is on a substrate 200 that comprises a row decoder 221 for selecting a row, column decoder 222 for selecting a column and voltage generator 251 for providing analog voltages to tune cavities.

The substrate will most typically be made of silicon, but other types of substrates can be selectively used based on either the properties required for the MFPI array and/or the environment in which it will be operating, including but not limited to silicon-on-sapphire, glass and diamond substrates.

### FIG. 8: Cavity Spacing Change

FIG. 8 is a side view of two elements 110 of an arbitrary m×n dimensioned MFPI array 100 where the right-hand-side cavity has a different cavity spacing 161 than the left-hand-side cavity. By having a different cavity spacing, each cavity 110 can be independently tuned to pass a different waveband, if desired.

### FIG. 9: Bottom Mirror/Mirror Segments

FIG. 9 is a top view of a bottom mirror 130, showing multiple bottom mirror segments 131, used for correcting non-parallelism between a top mirror 120 (not shown) and a bottom mirror 130. In this example, the bottom mirror 130 comprises three mirror segments 131. Different numbers of mirror segments, and different geometries for the mirror segments can be used. Then anchors 150 are shown in order to establish the relative position between the bottom mirror 130 and the top mirror 120.

### FIG. 10: Top and Bottom Mirror

FIG. 10 is a top view of an MFPI cavity 110 with a top mirror 120, bottom mirror 130, four cantilevers 140, four anchors 150 and a pixel boundary 111. The top mirror 120 overlays the bottom mirror 130. The cantilevers are shown with a schematic texture as an observation aid.

The pixel boundary 111 is the “edge” of pixel as pertains to its geometrical arrangement. This is an important characteristic for providing a reference to align all the structure components that include cantilevers, anchors and mirrors in their relative positions with the necessary optical precision for optical interference, non-uniformity compensation, spectral tuning, array processing and other array operations.

### FIG. 11: Input Circuit

FIG. 11 is an example input circuit 210 with row select 231, column select 232, select transistor 230, integrating capacitor 240, and a connection made to an MFPI cavity 110. In an array, the input circuit selects the MFPI cavities 110 and controls the voltage applied to the cavities.

### FIG. 12: Gas Sensing—Single Element

FIG. 12 is a gas sensing system 500 with an MFPI element 110, infrared source 510, collimating lens 511, a gas path length 512, cavity controller 260, detector controller 270, and control processor 280, with a single detector element 410 in the gas sensing system for a single type of gas 520. The IR source 510, which can be supplied by the system or can be an ambient source, generates IR radiation which passes through the collimating lens 511, through the gas 520, through the MFPI element 110, and onto the detector element 410.

The MFPI element 110 can be tuned sequentially to multiple wavelengths to detect multiple gas types. Example gas types include, but are not limited to flammable, polluting, and toxic gases. If an array of multiple MFPI elements 110 is used with a detector array 400 of multiple detector elements 410, multiple gas types can be simultaneously sensed when different elements 110 are tuned to different wavelengths.

### FIG. 13: HS Imaging & Gas Cloud Sensing

FIG. 13 is a hyper-spectral imaging and gas cloud sensing system 600 useful for hyper-spectral imaging or gas cloud sensing comprising an MFPI array 100 of multiple MFPI elements 110, an infrared detector array 401 of multiple detector elements 410, an imaging lens 620, an MFPI array controller 261, a detector array controller 271, and a target with background or IR source 610.

In this example the micro fabry-perot interferometer array 100 is aligned optically with the infrared detector array 401, both having identical spatial resolution. However, in the imaging and gas cloud sensing system 600, the cavities of the respective arrays can be permanently or variably tuned in spectral, spatial, and temporal behaviors, or some combination of these behaviors.

### FIG. 14: Scene Projection

FIG. 14 is a scene projection system 700 comprising a laser source 710 and laser controller 711, a micro fabry-perot interferometer array 100 and a micro fabry-perot interferometer array controller 261, a collimating lens 511, a focusing lens 730, and a sensor 720 and a sensor controller 721. The array 100 is illuminated by the laser source 710 to generate complex, dynamic scenes which are projected onto the sensor 720 under test.

For scene projection, again, the cavities of the array can be permanently or variably tuned in spectral, spatial, and temporal behaviors, or some combination of these behaviors to generate a scene or a series of scenes from the array onto the sensor under test when it is illuminated by a source.

### FIG. 15: Scene Projection—Intensity Modulation of Source

FIG. 15 is a plot of variation in intensity of a laser beam over a range of wavelengths (the laser intensity profile 740), for a particular target spectrum of interest to scene projection. The primary projected wavelength 741 is the wavelength of highest intensity in this profile.

The intensity about this primary wavelength can be selectably varied by tuning the MFPI cavity to pass narrower wavebands 742 (subsets of the available spectrum) within this profile to project different intensities onto the sensor under test.

### FIG. 16: Scene Projection—Multiple Sources

FIG. 16 is a scene projection system 700 capable of projecting complex scenes in multiple spectral regions onto a target sensor 720. In this instance, the system 700 uses four separate laser sources: an ultraviolet laser source 712, a visible light laser source 713, a mid-wave infrared laser source 714, and a long-wave IR laser source 715. Each laser source has an MFPI array 100 and collimating lens 511, both array and lens are specifically tuned for a particular spectral region. The different scenes are combined through the use of multiple beam splitters 750 and focused onto the sensor under test 720 using a projection lens 760.

Scenes may be generated through use of a single source or any combination of sources.

### Preferred Embodiments

### Micro Fabry-Perot Interferometer Array 100

As shown in FIGS. 1-7, a micro fabry-perot interferometer array 100 can comprise n horizontal and m vertical cavities, where n and m can range from one to thousands or even millions depending on the application. It can also comprise integrated circuits for a row decoder 221, column decoder 222 and voltage generator 251, as shown in FIG. 7. Additionally, the array can extend into other dimensions, i.e., a “stacked” array in three dimensions.

In a preferred embodiment, the array is first fabricated by a complementary-metal-oxide-semiconductor (CMOS) foundry on either a silicon (Si) or a silicon-on-sapphire (SOS) substrate 200 to contain the integrated circuits, followed by fabricating the cavities on top of the integrated circuits by a micro-electro-mechanical-system (MEMS) foundry. Substrate 200 made with Si is used to process arrays for mid wave infrared (MWIR) through long wave infrared (LWIR) spectral regions, while substrate 200 made with SOS is used to process arrays for ultraviolet (UV) and visible (V) spectral regions. Other substances can also be used for the substrate depending upon the required system characteristics and other environmental factors, e.g., low-operating temperature, high shock resistance.

The row decoder 221 selects one row of cavities and then the column decoder 222 selects one cavity from the selected row for tuning by a voltage predetermined by voltage generator 251. When all rows and columns are selected sequentially, all cavities are tuned sequentially with different voltages to transmit different wavebands within one frame time determined by a selection timing sequencing set by the row decoder 221 and column decoder 222. Made with low mass and low capacitance time constant, each cavity can be tuned from one waveband to the next within about a microsecond, determined by the cavity surface area, whereby allowing the array to have a frame rate ranging from 1 Hz to about 1,000 Hz.

### Turning the Micro Fabry-Perot Interferometer Cavity 110

Each pixel of micro fabry-perot interferometer array 100 is a micro fabry-perot interferometer cavity 110, consisting of at least two parallel mirrors made with multiple dielectric layers sandwiching a free-space cavity with a narrow cavity spacing 161, as shown in FIGS. 4 and 5. In an example configuration, a top mirror 120, one of the two parallel mirrors, is made movable by its suspension in midair, supported at its four corners by a set of four cantilevers 140. (See FIGS. 1-3, and 10.) The other ends of the cantilevers are anchored to substrate 200 by a series of anchors 150.

As incident radiation beam 300 enters the cavity, it is divided by reflections into multiple beams interfering with one another to produce an emergent waveband with a narrow bandwidth 310 and a central wavelength determined by the mirror reflectivity and the cavity spacing, respectively. Tuning the cavity is made by changing cavity spacing 160, accomplished by applying a voltage across the cavity to flex the four compliant cantilevers, causing the top mirror 120 to move relative to bottom mirror 130 fixed to substrate 200, tuning the cavity to transmit a narrow waveband. The intensity of transmitted waveband 310 is given by:

$$I = \frac{{I}_{0} {T}_{0}^{2}}{{[ 1 - R ]}^{2} [ 1 + \frac{4 R}{{( 1 - R )}^{2}} {sin}^{2} ( \frac{2 π nd cos φ}{λ} ) ]} , \qquad ( 1 )$$

where:
I₀=Incident radiation beam intensity
T₀=Mirror transmittance˜1,
R=Mirror reflectivity,
n=Cavity refractive index,
d=Cavity spacing,
φ=Angle of incidence,
λ=Wavelength of incident radiation beam, and
Φ=(2πnd cos φ)/λ, the phase retardation of interference,
m=Order of interference.

Bandwidth 330 (δλ_{R}) of transmitted waveband 310 is given by

$${δλ}_{R} = \frac{λ ( 1 - R )}{m π {R}^{1 / 2}} . \qquad ( 2 )$$

Free spectral range 340 (Δλ) of the fabry-perot interferometer cavity is given by:

$$Δλ = \frac{λ}{m} . \qquad ( 3 )$$

### Top Mirror 120

Top mirror 120 consists of at least two and a half bilayers of thin dielectric films, as shown in FIG. 5, showing bilayer 170 made of first dielectric layer 171 of high refractive index and second dielectric layer 172 of low refractive index. Both dielectric layers are transparent in the spectral region of interest; for example, for the UV and V spectral regions, one layer might be magnesium fluoride and the other might be titanium oxide; for the MWIR region, one layer might be silicon and the other silicon dioxide; and for the LWIR region, one layer might be germanium and the other zinc sulphide. Many other bilayer 170 combinations are possible to cover these spectral regions. The choice of layer materials depends on the application of interest. To achieve a high reflectivity greater than 0.95, typically two or more bilayers are required.

The thickness of first dielectric layer 171 and second dielectric layer 172 depends on the spectral region determined by the application. It must be one quarter of the optical wavelength in the layer medium. For example in designing top mirror 120 for the 10.0-10.5 micron spectral region, one layer might be germanium whose thickness should be a quarter of the optical wavelength in the germanium medium, that is, one quarter of 10 micron divided by 4, the refractive index of germanium. The layer thickness for other spectral regions is computed likewise.

To facilitate applying of a voltage across the cavity for tuning, the bottom layer of top mirror 120, the layer closest to air-gap cavity 161, is made more electrically conducting than other layers by doping so that when an electrical contact is made to it, it uniformly distributes the voltage across this layer.

### Bottom Mirror 130

In the example shown on the drawings, the bottom mirror 130 is partitioned into at least three segments 131, each made with a set of bilayers. It is identical to top mirror 120, except that it has 3 instead of 2.5 bilayers made so to achieve a high reflectivity. These bilayers are divided into three segments, with the topmost layer, the layer closest to air-gap cavity 161, made more electrically conducting than other layers to ensure that an applied voltage 250 is uniformly distributed on this layer. Different voltages may be individually applied to these segments for tilting top mirror 120 into parallel with bottom mirror 130, correcting any non-parallelism that might have been created during fabrication.

### Cavity Spacing 160

Sandwiched between top mirror 120 and bottom mirror 130 is an air-gap cavity 160 with a narrow cavity spacing 161, as shown in FIGS. 4, 5, and 8, which is changeable by moving top mirror 120 towards or away from bottom mirror 130, which remains fixed to substrate 200. Although the figures used illustrate only the movement of the top mirror, the invention is broader in scope, and includes the ability to securely fix the top mirror(s) and move the bottom mirror(s), or to move both top and bottom mirror(s) relative to one another.

For a given application, cavity spacing 160 may be preset to a value required by the spectral region of interest determined by the application. For example, for gas sensing, the cavity spacing 160 would be preset at about 2.5 micron, about one half of the maximum wavelength in the MWIR (3-5 micron) spectral range, which contains most of the absorption bands of gases of interest. For scene projection, the cavity spacing 160 would be preset at about 5 micron to match a LWIR (8-10 micron) spectral region that is usually employed for scene projection. For UV imaging, the cavity spacing 160 would be preset at about 0.15 micron to match the UV (0.22-0.30 micron) spectral region of interest.

### Support Structures; Cantilevers 140

In the examples shown, four support structures, in this instance, cantilevers 140 are used to suspend the top mirror 120 in midair. In these examples each cantilever consists of a beam with a long length, a narrow width, a small thickness, and a low Young's modulus in order to achieve a high compliance for moving top mirror 120 over large distances. Generally, the higher the compliance the easier is to flex the cantilevers, and the less voltage is needed to cause a large change in cavity spacing 160 for tuning over a larger spectral range to suit applications of interest. Its length, made to conform to the periphery of top mirror 120 in order to enhance the mirror fill-factor, as shown in FIG. 3, may be varied according to applications. For example, it can be made as a short stub for making only small changes needed in the visible spectral region for display applications. On the other hand, it can be made longer by wrapping it round two sides of top mirror 120, as shown in FIG. 3, making possible large cavity spacing 160 changes of over 3 microns, needed in infrared scene projection applications.

The materials used for making the cantilevers may vary from metal, copolymer to rubber. Typically, for most applications, metal such as Aluminum is suitable. However, for extremely large changes in excess of 3 microns, copolymers may be used. Generally, voltages needed to provide changes in cavity spacing 160 for applications of interest are kept to below 25 volts compatible to conventional CMOS integrated circuits used for the arrays.

### Anchors 150

In the examples shown, each of the four cantilevers 140 are secured to the substrate 200 using an anchor 150. Typically, each anchor consists of a column of electroplated metal with a rectangular cross-section. The height of each anchor may be varied from about 0.15 to 5 microns, depending on the spectral region and application of interest. Electroplating is one of the preferred methods for fabricating the anchors, but other methods are also acceptable, such a spin-on photo-resist and copolymers. Copper, gold and nickel are examples of metals used for electroplating. When electroplated metal is used, the resultant anchors serve several purposes including: anchoring cantilevers to substrate 200, presetting cavity spacing 160 to a value to suit a spectral region of interest, providing an electrical contact between the bottom layer of top mirror 120 and the input circuit 210 on substrate 200, and defining a pixel boundary 111, as shown in FIG. 10.

### Transmitted Waveband 310

Shown in FIG. 5, the transmitted waveband 310 consists of a narrow spectral band with narrow bandwidth 330 determined by the reflectivity of the mirrors, and a tuned central wavelength determined by the size of cavity spacing 160.

### Input Circuit 210

Input circuit 210 consists of a select transistor 230, integrating capacitor 240, row select 231, column select 232, and voltage input 250, as shown in FIG. 11. A cavity 110 of the micro fabry-perot interferometer array 100 may be selected by a pulse input to row select 231 and column select 232, inputting a voltage into the selected cavity for tuning.

### Micro Fabry-Perot Interferometer Array Fabrication

The preferred method of fabricating a micro fabry-perot interferometer array 100 usually constitutes two separate processes: the CMOS process for fabricating the integrated circuits to operate the cavities on either silicon (Si) substrate or silicon-on-sapphire (SOS) substrate, and the MEMS process for fabricating the cavities on top of the processed integrated circuits. Both processes can be carried out by commercial foundries. The key steps for fabricating a micro fabry-perot interferometer array 100 (using the example Si or SOS wafer) are as follows:
(a) obtaining either a Si or SOS wafer;
(b) processing the CMOS integrated circuits by CMOS process;
(c) transferring the processed wafers to the MEMS foundry;
(d) processing the bottom mirrors on the processed wafer;
(e) electroplating the metal anchors;
(f) processing a sacrificial layer with a spin-on polyimide to form a platform on which to process the cantilevers and top mirrors;
(g) processing the cantilevers on the anchors;
(h) processing the top mirror's cantilevers;
(i) removing the sacrificial polyimide layer; and
(j) packaging the array on a carrier;

The material composition of the substrates noted (Si, and SOS) above were offered as merely examples of the types of substrates that would more commonly be used in the fabrication of an MFPI array and associated circuits. As is obvious to those skilled in the art, other substrate exist and would be selected (e.g., glass, GaAs, diamond) depending on the material properties required for the array and/or for the environment for which the array was expected to operate.

### Gas Sensing

For gas sensing, a micro fabry-perot interferometer array 100 may be configured as a single micro fabry-perot interferometer element 110 with cavity spacing 160 preset to an appropriate value to cover the usual MWIR gas absorption bands of interest. This configuration is depicted in FIG. 12, showing a gas cloud 520 of interest and a suitable gas path length 512 for detection. The cavity is tuned sequentially to wavebands corresponding to the absorption wavebands of suspect gas species in gas cloud 520. The detected signals are then used to compute the concentration of the gas species. For example, for detecting a methane gas, the absorption waveband centered at wavelength of about 3.39 micron and a path length of about 6 inches may be used. Other gases will require tuning the cavity to other wavebands and using a different path length. For the best detection, the strongest band is always used if the gas has more than one absorption band, as shown in the gas examples below identifying the strongest band first for each of the gases:

TABLE 9.11
Wavelengths for example gas types

| | | Wavelength (microns) | | |
|---|---|---|---|---|
| | | Strong | Medium | Weak |
| Flammable gases: | Hydrocarbons | 3.39 | 2.67 | |
| | Carbon monoxide | 4.65 | 4.31 | |
| Polluting gases: | Nitrogen dioxide | 6.17 | 5.71 | 3.45 |
| | Hydrochloride | 3.57 | 4.27 | |
| Toxic gases: | Hydrogen fluoride | 2.86 | 2.47 | 3.27 |
| | Hydrogen sulfide | 2.63 | 4.24 | 3.70 |

Using a single cavity, as shown in FIG. 13, cavity spacing 160 is electrically changed in a rapid sequence to cover the wavebands absorbed by the gases to be detected, in addition to one background waveband not absorbed by these gases as a reference. These actions produce a sequence of signals, one for each waveband, by the detector element 410. Depending on the number of gases to be detected, this sequence usually takes no more than a few milliseconds to complete, so that the detection of these gases is almost simultaneous. The concentration of each gas using its signal along with the signal of the reference is computed, according to:

$$\begin{matrix}\begin{matrix}SG = signal of gas \\ = γ . I 0. exp ( - α G . CG . x ) ,\end{matrix} & ( 4 ) \\ \begin{matrix}SR = signal of reference \\ = γ . I 0. exp ( - α R . CR . x ) ,\end{matrix} & ( 5 ) \\ \begin{matrix}Q = SG / SR . \\ = exp ( - α G . CG . x ) / exp ( - α R . CR . x ) \\ ∼ exp ( - α G . CG . x ) ,\end{matrix} & ( 6 ) \\ CG = ( Log Q ) / ( α G . x ) , & ( 7 )\end{matrix}$$

where:
αG=absorption coefficient of gas,
CG=concentration of gas,
αR=absorption coefficient of reference˜0
CR=concentration of reference˜0
x=path length of gas,
I0=incident IR radiation, and
γ=system constant.

Once its absorption coefficient (αG) and its path length (x) are obtained by calibration, the concentration (CG) for the gas is determined using equation 7. In this method, infrared source 510 can either be a man-made source, such a heated globar or laser source 710, or the background infrared radiation emitted by the atmosphere. Detecting very low concentrations (e.g., less than one part per million (1 ppm)), an intense infrared source 510, such as a laser, may be used with advantage; while detecting higher concentrations the infrared background source may suffice, and if not, the globar source may be used. The gas sensing system shown in FIG. 12, as a result of its ability to tune to many wavebands over a large spectral range, is more selective in sensing, detecting more gases nearly simultaneously, and more capable in computing concentrations during sensing, compared with a conventional gas sensor.

When high concentrations (e.g., greater than 10 ppm) of gases are being detected, the first-order equation 7 suffices to produce a reasonably accurate concentration determination. However, for low levels less than 1 ppm, a higher-order equation is needed to provide a reliable determination. At low levels, and when the low infrared background is used for illumination, the absorption coefficient of a typical gas is highly non-linear due to radiation scattering by the gaseous environment, making the first-order linear equation 7 inaccurate for concentration determination. To account for the non-linearity in absorption, a polynomial equation of the 2nd order is used:

CG=AO+A1.Log(Q)+A2.[Log(Q)]² (8),

where AO, A1 and A2 are concentration coefficients for a gas in the absorbing environment. These coefficients are predetermined by calibration of the gas sensing system with known gas concentrations.

To those who are familiar with the state of the art, the gas sensing system configuration described above is also applicable to sensing multiple gases quasi-simultaneously. In fact, all the flammable, polluting and toxic gases mentioned above can be detected almost simultaneously by a single cavity gas sensing the system described above. This simultaneous detection of many gases allows the system recognize signatures of groups of several gases peculiar to different environments. Then the system is capable of providing quantitative as well as qualitative analysis of the environment containing a mixture of gases. However, as we will see in the next section describing gas cloud sensing, this signature sensing is carried out even more simply, elegantly and powerfully using micro fabry-perot interferometer array 100 in place of a single fabry-perot cavity described above.

### Gas Cloud Sensing

For sensing a gas cloud 520, an example MFPI array 100 is configured as an n×m array aligned with an n×m infrared detector array 114, as shown in FIG. 13. In this drawing, the gas cloud is identified as a generic “target” 610. For this purpose, the MFPI cavity 110 is structured with an appropriate cavity spacing 160 to cover the MWIR gas absorption bands of interest, as most gases of interest have dominant absorption bands in the MWIR, rather than in the NIR or LWIR region. This configuration is almost identical to that used in a hyper-spectral imaging, except that the gas cloud 520 might be illuminated by infrared source 610 or by the infrared in the background itself. The descriptions for gas sensing using a single cavity 110 apply exactly to each cavity in MFPI array 100 used in the gas cloud sensing system. However, the gas cloud sensing system using MFPI array 100 offers additional and substantially more capabilities that might be highlighted as follows:
(a) tuning all cavities of the array to a waveband absorbed by a gas, a spatial distribution of that gas is sensed, showing how gas in gas cloud 520 is dispersed over a spatial extent, and how the gas concentration varied in space;
(b) tuning all cavities of the array to one waveband and taking many frames at different times, a sequence of spatial distributions of one gas is sensed, showing how the gas concentration in gas cloud 520 varies with time and space;
(c) tuning all cavities of the array to different absorbing wavebands sequentially, a sequence of spatial distributions of different gases is sensed, showing the different gases mixed in gas cloud 520;
(d) tuning each cavity of the array to a different absorbing waveband, a single distribution of different gases corresponding to the different absorbing wavebands is sensed, showing an instant snapshot of all the different gases present in gas cloud 520;
(e) tuning each cavity of the array to a different absorbing waveband corresponds to a suspect reaction gas product, a single distribution of the different gas reaction products corresponding to the tuned absorbing wavebands is sensed, showing an instant snapshot of all the different gas reaction products that might have been created by a chemical reaction; and
(f) tuning the cavities of the array variably, spectral, spatial, temporal, chemical, reactive and concentration behaviors of a gaseous environment may be sensed near simultaneously by the system.

The above shows only a few examples of capability of gas cloud sensing system using an electronically tunable micro fabry-perot interferometer array, as those skilled in the art are now aware.

### Hyper-Spectral Imaging

For hyper-spectral imaging, an example micro fabry-perot interferometer array 100 is configured with a 2-D infrared detector array 401, as shown in FIG. 14, similar to that system used for gas cloud sensing. The spatial resolution of MFPI array 100 to be used depends on the application; for example, to obtain detailed features of skin lesions, a resolution as high as 1,024×1,024 might be required, while imaging a field of insect-infested vegetation, a resolution of about 256×256 might suffice. Many different image formats may be obtained from the hyper-spectral imaging system: one format might a 2-D spatial image containing a different spectral content on each pixel; another might be a spatial image containing a single waveband on all pixels; yet another might different segments of the spatial image containing different spectral contents. To those familiar with the art of imaging, like gas cloud sensing system, the hyper-spectral imaging system using an MFPI array 100 offers substantially more capabilities than merely imaging, a few examples are highlighted as follows:
(a) tuning all cavities of the array to one waveband, a spatial image of the select waveband is obtained, highlighting any objects that are rich in that waveband;
(b) tuning all cavities of the array to one waveband and taking many frames at different times, a sequence of spatial images of the select waveband is obtained, showing the temporal behavior of the imaged objects and background;
(c) tuning all cavities of the array to different wavebands sequentially, a sequence of spatial distributions of different wavebands is obtained;
(d) tuning each cavity of the array to a different waveband, a single spatial distribution of different wavebands is obtained, showing an instant snapshot of all the different spectral contents present in the imaged scene;
(e) tuning certain segments of the array to different wavebands to correspond to different targets, these targets may be extracted from clutter easily; and
(f) tuning the cavities of the array variably, spectral, spatial, temporal behaviors of an environment may be imaged nearly simultaneously by the system.

### Scene Projection

For scene projection for sensor testing, an example micro fabry-perot interferometer array 100 is configured in FIG. 14. The spatial resolution of MFPI array 100 to be used depends on the spatial resolution of the sensor under test 720; for example it might be about 640×480, the common array size of most infrared detector arrays in current use. Many different scenes with different intensities and wavelengths may be generated by the MFPI array 100 and then projected onto sensor under test 720. When four different spectral MFPI arrays 100 are used, as shown in FIG. 16, extraordinarily complex UV, V, MWIR and LWIR scenes can be projected in unison onto sensor under test 720 for testing. The UV array modulates ultraviolet laser 712 (e.g., cascade GaN) or source, the visible array modulates visible laser 713 (e.g., He/Ne) or source, the MWIR array modulates mid wave infrared laser 714 (4,5-micron cascade laser) or source, and the LWIR modulates long wave infrared laser 715 (10.6-micron carbon dioxide laser) or source. Each array is a single microchip, each pixel of which is capable of modulating the laser beam as fast as 1 microsecond, providing an intensity dynamic range as high as 1,000,000:1, and producing narrow bands of UV, visible light, MWIR or LWIR. The scene projection system generates and projects scenes in the following way:
(a) tuning each cavity of an array in about 1 microsecond to pass a narrow waveband of UV, V, MWIR or LWIR, producing a band narrower than laser intensity profile 740 shown in FIG. 15;
(b) determining the intensities of these narrow wavebands by the wavelengths that the cavities are tuned to pass;
(c) tuning all cavities independently to produce a 2-D dynamic scene of complex intensities;
(d) using the generated scenes of considerable fine structures to simulate complex targets or object body structures and background clutter that sensor under test 720 will encounter;
(e) using four arrays to construct a complete projection system covering the entire spectral range of UV-LWIR, as shown in FIG. 16; and
(f) controlling each array by its own controller and collimating the scenes onto the sensor under test 720 by its own lens and beamsplitter.

### Optical Communications

In optical communications, a micro fabry-perot interferometer array 100 can be configured for:
(a) Wave Division Multiplexing (WDM) and Dense Wave Division Multiplexing (DWDM) applications using either the 1.3-micron or the 1.5-micron optical communications spectral regions, for which optical fibers and fast InGaAs detector arrays are available;
(b) last-mile optical communications in either the 1.5-micron or the 10-micron spectral region, for which the InGaAs and microbolometer arrays are available, respectively; and
(c) microchip-to-microchip optical interconnect using the 1.06-micron spectral region, for which ordinary silicon arrays are available.

For last-mile optical communications, MFPI array 100 can be configured either for the 1.06-micron wavelength to take advantage of the availability of the powerful Yag laser and the high sensitivity of silicon detector arrays, or for the 10-micron wavelength to take advantage of the powerful carbon dioxide laser, dense microbolometer arrays for the LWIR, and the high atmospheric transmission at 10 micron. For microchip-to-microchip optical interconnect, for which the short free-space distance of less than 0.5 meter involved requires only 1.0-micron wavelength where silicon detector arrays and light-emitting diodes are available.

The key to last-mile and microchip-to-microchip optical communications is an MFPI array 100, which is capable of providing massively-parallel optical channels for data transmission as follows:
(a) illuminate the interferometer array with a laser;
(b) tuning each cavity of the interferometer array to transmit a specific waveband as a specific optical channel as carrier for transmission;
(c) code each waveband with data (using one of several conventional methods);
(d) transmit the coded wavebands through free space;
(e) receive the transmitted wavebands by an array of infrared detectors; and
(f) decode the detected wavebands into data.

Thus the reader can see that the electrically-tunable micro fabry-perot interferometer array 100 of the invention has applications of great importance in gas sensing, hyper-spectral imaging, scene projection, and optical communications areas.

While the above description contains many specificities to help the reader to comprehend and appreciate the innovation and diversity of application of the invention, these should not be construed as limitations on the scope of the invention, but rather as an exemplication of many of the one preferred embodiments thereof. Many other variations are possible.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

We claim:

1. An array of micro fabry-perot cavities for tuning radiation wavebands, wherein said array comprises at least one cavity in a first dimension and at least one cavity in at least one other dimension.

2. An array as in claim 1 wherein said first and at least one of said other dimensions are orthogonal to one another.

3. An array as in claim 1 wherein said first and other dimensions are at some angle other than orthogonal to one another.

4. An array as in claim 1 wherein said array further comprises circuits to tune the cavities and operate the array.

5. An array as in claim 1 wherein each cavity of the array comprises:
a top mirror comprising at least one top mirror segment and
a bottom mirror comprising at least one bottom mirror segment,
wherein said top and bottom mirror sandwich an air-gap cavity with a cavity spacing.

6. An array as in claim 5 wherein said top mirror comprises a plurality of mirror segments.

7. An array as in claim 5 wherein said bottom mirror comprises a plurality of mirror segments.

8. An array as in claim 5 wherein said top mirror is suspended by at least one support structure.

9. An array as in claim 8 wherein said at least one support structure is a cantilever.

10. An array as in claim 8 wherein said cantilever is parallel to one side of the top mirror.

11. An array as in claim 8 wherein some portion of said cantilever is parallel to two neighboring sides of the top mirror.

12. An array as in claim 8 wherein said support structure is firmly anchored to a substrate via at least one anchor.

13. An array as in claim 8 wherein said top mirror is moved via said support structure(s) relative to a bottom mirror.

14. An array as in claim 13 wherein said movement of said top mirror results from the flexing of said support structure(s).

15. An array as in claim 13 wherein said movement of at least one segment of said top mirror towards or away from at least a segment of said bottom mirror results from an electrostatic force created by applying a voltage across the air-gap cavity.

16. An array as in claim 5 wherein a voltage applied to at least one bottom mirror segment causes at least one top mirror segment to become substantially parallel with the bottom mirror.

17. An array as in claim 5 wherein the movement of at least one top mirror segment corrects for non-parallelism between said top mirror and said bottom mirror.

18. An array as in claim 5 wherein a voltage applied to at least one bottom mirror segment changes the distance from the top mirror to the bottom mirror, changing the cavity air-gap to a distance corresponding to at least one spectral waveband.

19. An array as in claim 5 wherein the movement of said at least one top mirror segment tunes the cavity to transmit at least one spectral region.

20. An array as in claim 5 wherein said cavity spacing is preset in order to generate at least one spectral region.

21. An array as in claim 5 where the cavity spacing is preset to generate at least one specific spectral region via altering the height of at least one of the support structure's at least one anchor.

22. An array as in claim 5 where a cavity can be tuned from a first waveband to a second waveband in less than 1 microsecond.

23. An array as in claim 5 where the frame rate of the array is up to 1,000 Hz.

24. An array as in claim 5 wherein each of said mirrors comprises at least one bilayer.

25. An array as in claim 5 wherein each of said mirrors comprises a plurality of bilayers.

26. An array as in claim 25 wherein each of said bilayers comprises a dielectric film of high refractive index and a dielectric film of low refractive index, producing a specific reflectivity in the two mirrors.

27. An array as in claim 26 wherein said dielectric film of high refractive index closest to and on either side of the air-gap cavity comprises a doped medium so that the film is more electrically conducting than the film of low refractive index, producing a uniform distribution of an applied voltage over the film.

28. An apparatus for gas sensing comprising at least one micro fabry-perot interferometer element, at least one detector element, an infrared source, a collimating lens, a gas path length, a cavity controller, a detector controller, and a control processor, wherein gas of a specific type located between the infrared source and said at least one micro fabry-perot interferometer element can be detected.

29. An apparatus as in claim 28 comprising an array of micro fabry-perot interferometer elements, a multi-element infrared detector array, an imaging lens, an infrared detector array controller, and a micro fabry-perot interferometer (MFPI) array controller, wherein a plurality of gas types located between the infrared source and said micro fabry-perot interferometer array can be detected simultaneously.

30. An apparatus as in claim 29, wherein all cavities of said MFPI array are tuned to a waveband absorbed by a gas in a gas cloud, to obtain a spatial distribution of the gas.

31. An apparatus as in claim 29, wherein all cavities of said MFPI array are tuned to different wavebands absorbed by different gases sequentially, to obtain a sequence of spatial distributions of different gases in the gas cloud.

32. An apparatus as in claim 29, wherein all cavities of said MFPI array are tuned to a different waveband absorbed by a different gas, to obtain a single distribution of different gases in the gas cloud.

33. An apparatus as in claim 29, wherein all cavities of said MFPI array are tuned to a waveband absorbed by a gas product resulting from a chemical reaction, to obtain a single distribution of different gas products.

34. An apparatus as in claim 29, wherein all cavities of said MFPI array are tuned to variably, to obtain spectral, spatial, temporal, chemical reaction and concentration distributions of the gas cloud nearly simultaneously.

35. An apparatus as in claim 29, further comprising:
A. means of tuning all cavities of the interferometer array to a waveband absorbed by a gas in a gas cloud, to obtain a spatial distribution of the gas;
B. means for tuning all cavities of the interferometer array to different wavebands absorbed by different gases sequentially, to obtain a sequence of spatial distributions of different gases in the gas cloud;
C. means for tuning each cavity of the interferometer array to a different waveband absorbed by a different gas, to obtain a single distribution of different gases in the gas cloud;
D. means for tuning each cavity of the interferometer array to a waveband absorbed by a gas product resulted from a chemical reaction, to obtain a single distribution of different gas products; and
E. means for tuning said cavities of the interferometer array variably, to obtain spectral, spatial, temporal, chemical, reaction and concentration distributions of the gas cloud nearly simultaneously.

36. A method for gas sensing comprising:
A. collimating an infrared beam through a gas onto an interferometer element;
B. tuning the cavity of the interferometer element a first time to transmit a waveband absorbed by the gas;
C. tuning said cavity a second time to transmit another waveband not absorbed by the gas as a reference;
D. sensing the absorbed waveband and the non-absorbed waveband sequentially with a detector element; and
E. computing a concentration of the gas with a ratio of a signal due to the absorbed waveband to a signal due to the non-absorbed waveband, according to:
CG=A.Log(Q),
where CG is said concentration, Q is said ratio, and A is a constant obtained by calibration with a known concentration of the gas.

37. A method for gas sensing as in claim 36, further comprising a method for computing a low concentration if said low concentration is less than one part per million of said gas with said ratio, according to:
CG=AO+A1.Log(Q)+A2.[Log(Q)]²,
where CG is said low concentration, Q is said ratio, and AO, A1 and A2 are constants obtained by calibration with at least three known concentrations of said gas before sensing.

38. An apparatus for hyper-spectral imaging comprising a micro fabry-perot interferometer array, an infrared detector array, an imaging lens, an infrared-detector-array controller, and a micro fabry-perot interferometer (MFPI) array controller, wherein data collected by said array provides a multi-spectral, multi-spatial, and/or temporal image of targets and background.

39. An apparatus as in claim 38, wherein all cavities of said MFPI array are tuned to a specific waveband, to obtain a spatial image at said waveband.

40. An apparatus as in claim 38, wherein all cavities of said MFPI array are tuned to one waveband at different times, to obtain a sequence of spatial images at said waveband.

41. An apparatus as in claim 38, wherein all cavities of said MFPI array are tuned to different wavebands sequentially, to obtain a sequence of spatial images of said different wavebands.

42. An apparatus as in claim 38, wherein each cavity of said MFPI array is tuned to different wavebands, to obtain a single spatial image of different wavebands

43. An apparatus as in claim 38, wherein certain segments of said MFPI array are tuned to different wavebands to correspond to different targets, to obtain images of targets enhanced against background

44. An apparatus as in claim 38, wherein all cavities of said MFPI array are variably tuned to obtain spectral, spatial, and temporal images nearly simultaneously of targets and background.

45. An apparatus as in claim 38, further comprising:
A. means for tuning all cavities of the interferometer array to a specific waveband, to obtain a spatial image at said waveband;
B. means for tuning all cavities of the interferometer array to one waveband at different times, to obtain a sequence of spatial images of said waveband;
C. means for tuning all cavities of the interferometer array to different wavebands sequentially, to obtain a sequence of spatial images of said different wavebands;
D. means for tuning each cavity of the interferometer array to a different waveband, to obtain a single spatial image of different wavebands;
E. means for tuning certain segments of the interferometer array to different wavebands to correspond to different targets, to obtain images of targets enhanced against background; and
F. means for tuning cavities of the interferometer array variably, to obtain spectral, spatial, and temporal images nearly simultaneously of targets and background.

46. An apparatus for projecting scenes, comprising a micro fabry-perot interferometer (MFPI) array, a laser source, a collimator, a focusing lens, a laser controller, and an MFPI array controller, wherein the cavities of said MFPI array are independently tuned to generate at least one scene.

47. An apparatus as in claim 46 wherein said MFPI array generates a sequence of scenes.

48. An apparatus as in claim 46 wherein said scene(s) is projected onto a sensor under test.

49. An apparatus as in claim 46 wherein a short-wave infrared MFPI array is used to project short-wave infrared scenes.

50. An apparatus as in claim 46 wherein a mid-wave infrared MFPI array is used to project mid-wave infrared scenes.

51. An apparatus as in claim 46 wherein a long-wave infrared MFPI array is used to project long-wave infrared scenes.

52. An apparatus as in claim 46 wherein a visible frequency MFPI array is used to project visible scenes.

53. An apparatus as in claim 46 wherein an ultraviolet MFPI array is used to project ultraviolet scenes.

54. An apparatus as in claim 46 wherein at least two MFPI arrays and matched laser sources simultaneously project a scene comprising at least two different wavebands.

55. A method of testing a sensor using a micro fabry-perot interferometer (MFPI) array comprising:
A. illuminating at least one MFPI array with a laser source;
B. tuning at least some of the cavities of the MFPI array to at least one waveband producing at least one scene;
C. projecting the scene(s) onto the sensor under test; and
D. recording response of the sensor under test using a sensor controller.

56. An apparatus for optical communications comprising at least one micro fabry-perot interferometer (MFPI) array, at least one laser source, a projector lens, a laser controller, and an MFPI array controller, wherein at least one optical channel is coded with data for transmission through free space to at least one distant optical receiver.

57. An apparatus as in claim 56, wherein a plurality of optical channels are simultaneously coded with data for transmission.

58. An apparatus as in claim 56, wherein said at least one MFPI array and laser source transmit on short-wave infrared wavebands.

59. An apparatus as in claim 56, wherein said at least one MFPI array and laser source transmit on mid-wave infrared wavebands.

60. An apparatus as in claim 56, wherein said at least one MFPI array and laser source transmit on long-wave infrared wavebands.

61. An apparatus as in claim 56, wherein said at least one MFPI array and laser source transmit on visible wavebands.

62. An apparatus as in claim 56, wherein said at least one MFPI array and laser source transmit on ultraviolet wavebands.

63. An apparatus as in claim 56 wherein at least two MFPI arrays and laser sources are used to simultaneously transmit data on at least two separate wavebands.

64. An apparatus as in claim 56, wherein said optical communications provide for at least one microchip-to-microchip optical interconnect.

65. A method for transmitting data via optical communications comprising:
A. illuminating at least one micro fabry-perot interferometer (MFPI) array with a laser source;
B. tuning the cavities of the MFPI array to different wavebands producing different optical channels;
C. coding the optical channels with data for communication; and
D. projecting the optical channels through free space onto a distant receiver.

66. A method for fabricating a micro fabry-perot interferometer array, comprising:
A. obtaining a substrate of a specific material quality;
B. fabricating a set of integrated circuits for the array onto said substrate, using standard micro-electronic fabrication techniques;
C. fabricating the bottom mirrors above the integrated circuits;
D. creating a sacrificial layer above the bottom mirrors;
E. creating a supporting structure to be used to support the top mirrors within the sacrificial layer;
F. fabricating the top mirrors above the support structures; and
G. removing the sacrificial layer leaving behind said support structures;
thus, forming the array.

67. A method as in claim 66 wherein said substrate is Silicon.

68. A method as in claim 66 wherein said substrate is Silicon-on-Sapphire

69. A method as in claim 66 wherein said substrate is diamond

70. A method as in claim 66 wherein said substrate is glass.

71. A method as in claim 66 wherein said support structure is a cantilever.
